(19) United States
(12) Patent Application Publication
(10) Pub. No.: US 2025/0293775 A1
(43) Pub. Date: Sep. 18, 2025

(54) RESOLVING A TOPOLOGY OF A DYNAMIC NETWORK USING MACHINE LEARNING

(71) Applicant: Aalyria Technologies, Inc., Livermore, CA (US)

(72) Inventors: William HARRIS, London (GB); David MANDLE, Livermore, CA (US); Brian Kuan-shih FOO, Union City, CA (US); Brian James BARRITT, Pittsburg, PA (US)

(21) Appl. No.: 18/603,119

(22) Filed: Mar. 12, 2024

(51) Int. Cl. H04B 10/112; H04B 10/077

(52) U.S. Cl. CPC H04B 10/112; H04B 10/077

(57) ABSTRACT

Aspects of the present disclosure are directed to resolving connections among nodes of a dynamic network based on network conditions. Because environmental conditions can substantially impact the integrity of link(s) among node(s), implementations of a network topology tool can resolve node connections based on the current network conditions relative to the nodes. For example, a dynamic network can comprise nodes with modifiable connections, such as free-space optical communication nodes, radio frequency nodes, or any other suitable nodes with modifiable connections. The performance of the dynamic network can be impacted by conditions relative to the nodes, such as environmental conditions or other suitable network conditions. Using a representation of a universe of potential connections among the nodes and the network conditions, the network topology tool can resolve a topology for the network, such as determine which nodes to connect.

### TECHNICAL FIELD

The present disclosure is directed to resolving connections among nodes of a dynamic network based on network conditions.

### BACKGROUND

Free-space optical communication (FSOC), due to its high data rate, high capacity, free license spectrum, and high-level security, offers a wireless networking option that differs from the Radio Frequency (RF) or microwave communication in modern wireless communication. In a free-space optical communication system, a transmitter may transmit data at a high speed (e.g., greater than 1 Gbps, 10 Gbps, 100 Gbps, 1 Tbps, etc.) using a narrow laser beam (e.g., in infrared wavelengths) that passes through the atmosphere to a line of-sight receiver. Free-space optical communication can offer point-to-point data communication at rates faster than other available solutions, cover greater distances, offer connectivity where other supporting infrastructure is scare, and is not susceptible to RF-based jamming techniques intended to interfere and disrupt the operation of RF communication systems. For example, free-space optical communication systems may be used to provide links to, from, or between aircrafts, spacecrafts, balloons, satellites, ground vehicles and stations, and water-based vehicles and stations, and can deliver data services at high speed to sites that may otherwise have no access to high speed networks, such as fiber optical networks. Free-space optical communication can substantially improve satellite communications, connectivity on planes and ships, cellular connectivity, and other forms of connectivity.

### BRIEF DESCRIPTION OF THE DRAWINGS

FIG. 1 is an example of a communication network that may be implemented using free-space optical communication.

FIG. 2 is a block diagram illustrating an overview of an environment in which some implementations can operate.

FIG. 3A is an example of a bistatic free-space optical communication system.

FIG. 3B is an example of a monostatic free-space optical communication system.

FIG. 4 includes simplified block diagrams of examples of terminals in a free-space optical communication system according to some implementations.

FIG. 5A is an example of a machine learning model architecture for resoling network connections to define a topology for a dynamic network.

FIG. 5B is an example of a machine learning model architecture that iteratively resolves network connections to define a topology for a dynamic network.

FIG. 6 is an example of an architecture for training a machine learning model that iteratively resolves network connections to define a topology for a dynamic network.

FIG. 7 is a flow diagram illustrating a process used in some implementations for training a machine learning model that iteratively resolves network connections to define a topology for a dynamic network.

FIG. 8 is a flow diagram illustrating a process used in some implementations for iteratively resolving network connections to define a topology for a dynamic network.

FIG. 9 is a block diagram illustrating an overview of devices on which some implementations can operate.

The techniques introduced here may be better understood by referring to the following Detailed Description in conjunction with the accompanying drawings, in which like reference numerals indicate identical or functionally similar elements.

### DETAILED DESCRIPTION

Conventional wireless networks can implement a variety of technologies. Free-space optical communication systems offer high data rates, high capacity, cost effectiveness, security, and rapid deployment. However, optical signals transmitted through the air and/or atmosphere may be affected by environmental conditions, such as poor weather, air particulates, and other atmospheric conditions, before arriving at a receiver. For example, weather and/or other atmospheric effects can deteriorate the transmission by reducing the signal's optical power level due to attenuation, by causing interference, and/or by causing random optical power and phase fluctuations in the received signal results from, for example, beam spread, scintillation effects, and/or beam wander. Other wireless networking solutions, such as radio frequency and/or microwave communication subnetworks, can be implemented along with free-space optical communication networks to achieve network flexibility and comprehensive coverage.

Aspects of the present disclosure are directed to resolving connections among nodes of a dynamic network, such as a network with modifiable connections among free-space optical communication nodes and/or other wireless network nodes, based on network conditions. Because network conditions, such as environmental conditions and/or the other network links formed, can substantially impact the integrity of link(s) among node(s), implementations of a network topology tool can resolve node connections based on the current network conditions relative to the nodes. For example, a dynamic network can comprise nodes with modifiable connections, such as free-space optical communication nodes, radio frequency nodes, etc. Modifying connections among the nodes can include changing which nodes are connected. The performance of the dynamic network can be substantially impacted by conditions relative to the nodes, such as environmental conditions at the physical node locations or other suitable network conditions. Using a representation of a universe of potential connections among the nodes of the dynamic network and the network conditions relative to the nodes, the network topology tool can resolve a topology for the network, such as determine which nodes to connect.

In some implementations, at least a portion of the nodes of the dynamic network comprise point-to-point connections. The network topology tool can resolve a topology for the dynamic network by determining pairs of nodes for connection. Because the topology defined by the tool configures the dynamic network to perform under current network conditions (e.g., environmental conditions relative to the nodes of the network) the resolved topology may be tailored to optimize network performance under its operating conditions. In some implementations, the dynamic network can be a heterogeneous network such that one or more of the nodes comprise nodes with modifiable connections (e.g., free-space optical communication nodes, radio frequency nodes, etc.) and one or more of the nodes comprise wireless or wired connections (e.g., cellular nodes, local area network nodes, etc.) that are less modifiable or not modifiable.

The network topology tool can resolve a topology for the dynamic network using machine learning model(s). For example, a trained machine learning model can be configured to receive input related to the dynamic network and operating conditions for the dynamic network and determine which nodes of the network to connect. In some implementations, the trained machine learning model can: receive, as input, the network conditions relative to the nodes of the dynamic network, and a representation of the universe of potential connections among the nodes of the dynamic network; and predict, as output, resolved connections between pairs of particular ones of the nodes. For example, each resolved connection can be defined by the two nodes it connects. In other examples, resolved connections may connect multiple of the nodes of the dynamic network.

The set of resolved connections can define a first topology for the dynamic network. The dynamic network can be arranged according to the first topology by instructing its nodes to initiate, modify, or maintain connections that correspond to the resolved connections. Data can be propagated through the dynamic network when arranged according to the first topology. In this example, the topology of the dynamic network is tailored to its current operating conditions (e.g., environmental conditions experienced by its nodes, combination of node connections, etc.) to enhance network performance (e.g., transmission rate, bit error rate, latency, etc.). In some implementations, the topology of the dynamic network can be modified multiple times over a period of time, such as periodically (e.g., hourly, daily, weekly, monthly, or any combination thereof). These modifications can tailor the topology of the dynamic network to its operating conditions to maintain high-level network performance.

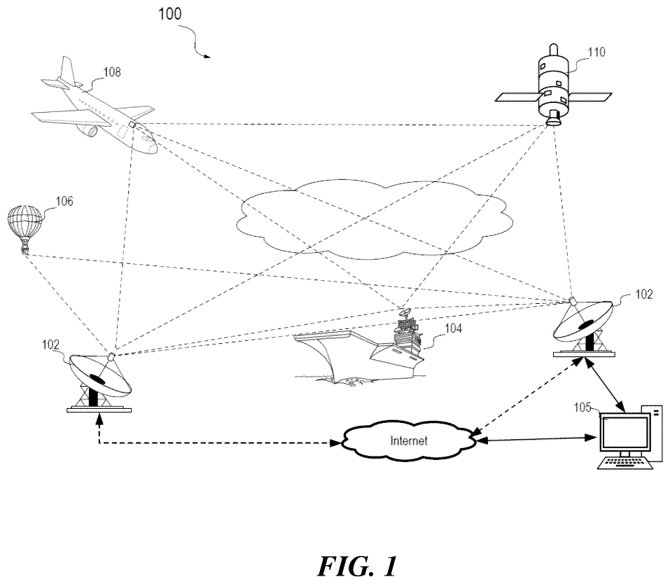

FIG. 1 illustrates an example of a communication network 100 that may be implemented using free-space optical communications. Communication network 100 may be a directional point-to-point communication network including network nodes (e.g., communication terminals) on various land-based, sea-based, air-based, or space-based structures, some of which may be mobile and can change position with respect to other nodes in communication network 100 over time. In the illustrated example, communication network 100 may include one or more datacenters 105, one or more land-based nodes 102, one or more sea-based nodes 104 (e.g., ships), and one or more airborne high altitude platforms (HAPs), such as one or more balloons 106, one or more airplanes 108, and one or more satellites 110. It is noted that communication network 100 shown in FIG. 1 is for illustration purposes only. In some implementations, communication network 100 may include additional or different network nodes. For example, in some implementations, communication network 100 may include additional HAPS, such as blimps, unmanned aerial vehicles (UAVs), or any other form of high altitude platforms. In some implementations, communication network 100 may serve as an access network for client devices such as cellular phones, laptop computers, desktop computers, wearable devices, or tablet computers. Communication network 100 may be connected to a larger computer network, such as the Internet, and may be configured to provide a client device with access to resources stored on or provided through the larger computer network.

Some network nodes in communication network 100 may communicate with each other using wireless communication links through the atmosphere. In some implementations, at least some nodes in communication network 100 may include wireless transceivers associated with a cellular or other mobile network, such as eNodeB base stations or other wireless access points, such as WiMAX or UMTS access points. Some land-based nodes 102, sea-based nodes 104, balloons 106, airplanes 108, and satellites 110 may communicate with datacenter 105 directly (e.g., through RF communication with an antenna of datacenter 105), through the Internet, through a network nodes (e.g., a land-based node 102), or through backbone network links or transit networks operated by third parties. Land-based nodes 102, sea-based nodes 104, balloons 106, airplanes 108, and satellites 110 may provide wireless access for the users, and can route user requests to the datacenters 105 and return responses to the users via the backbone network links.

Datacenters 105 may include servers hosting applications that can be accessed by remote users and systems that monitor and control the nodes of communication network 100. In some implementations, datacenter 105 may implement a software platform for orchestrating land-based nodes 102, sea-based nodes 104, balloons 106, airplanes 108, and satellites 110, and other land-based networks. For example, the software platform may optimize and continually evolve the network link scheduling, traffic routing, and spectrum resources in real time. In one example, the software platform may provide information (e.g., location information) to two nodes that need to establish a point-to-point direct optical link between the two nodes, so that the two nodes can find each other in the three-dimensional space and establish the direct optical link. In some embodiments, datacenter 105 may operate networks across land, sea, air, and space, at any altitude or orbit type, support many radio frequency bands and optical wavelengths, and may be designed for interoperability with legacy, hybrid space, 5G new radio, non-terrestrial network (NTN), and future generation network architectures.

Some nodes of communication network 100 may be configured to communicate with one another using steerable wireless transceivers. For example, land-based nodes 102, sea-based nodes 104, balloons 106, airplanes 108, and satellites 110 may include optical transceivers and thus may directly communicate with each other using point-to-point optical links through the atmosphere. The optical transceivers may be mounted to actuators (e.g., gimbals) that may be controlled to point in a desired direction. To form a link between two nodes, the transceivers of the respective nodes can be controlled (e.g., based on information received from datacenter 105) to point in the direction of one another so that data can be transmitted and received between the two nodes. In some implementations, some of the nodes may include transceivers with omnidirectional antennas and therefore are not required to be steered towards other nodes to form communication links. Some of the nodes may include directional transceivers whose positions and pointing directions may be fixed. In some implementations, parameters associated with each transceiver may be controlled to facilitate formation of the links in communication network 100. For example, nodes having steerable directional antennas can be controlled to point in the direction of nodes with which they are to establish links. In addition, the power of the signals transmitted by each transceiver can also be controlled to facilitate formation of the links in communication network 100. For example, transceivers of nodes that are separated by a relatively large distance can be configured to operate at a higher power to compensate for the loss of signal-to-noise ratio that occurs over the distance separating the two nodes. Transceivers of nodes that are spaced nearer to one another may be controlled to operate at a relatively low power so as to save power. The communication channels and protocols for pairs of nodes that are to establish links can also be controlled to facilitate the formation of the links in communication network 100.

In general, each directional transceiver can be aimed at only one other transceiver at a given time, and each transceiver may be able to operate at a sufficiently high power level in order to form a link with a transceiver of another node. Omnidirectional nodes may only be capable of forming a limited number of simultaneous communication links and may transmit or receiver data at a low bandwidth in each communication link. As a result, the feasible topologies and available bandwidth for communication network 100 at a given time may be constrained. For example, each network node may have a fixed number of transceivers, and thus the number of links coupling a first node to other nodes (sometimes referred to as the degree of the first node) may not be greater than the number of transceivers associated with the first node. Furthermore, the maximum range for each transceiver may be limited by the maximum power output for the transceiver, and therefore a link may not be established between a pair of nodes that are separated by a distance that exceeds the maximum range for either one of the transceivers. In some implementations, the maximum power output for a transceiver can be constrained based on a variety of factors, such as a battery level, weather conditions that may impact solar power generation rates, remaining flight time for a HAP, and the like.

Further constraint on the feasible topologies of communication network 100 may include the requirement that the path between a pair of nodes should be clear of obstructions in order for the nodes to form a line-of-sight link. In some implementations, the relative motion of the nodes in communication network 100 may prevent the formation of links at some points in time. For example, a link between a balloon 106 (or an airplane 108) and a land-based node 102 (land station) may become unreliable, unfeasible, or unavailable at times during which clouds, mountains, buildings, or other obstacles are positioned between the two nodes. Thus, movement of some nodes, as well as external events such as weather or failure of one or more transceivers, may limit the nodes that are reachable from a given node at a given time in communication network 100. As result, links and routing information may need to be continuously updated based on the respective locations of the network nodes and other properties of the network nodes to maintain connectivity across communication network 100 over time. In some implementations, an input graph representing all of the possible links that can be formed in the network at a given time can be generated and processed to generate a subgraph that conforms to the constraints discussed above while satisfying any provisioned network flows. For example, this subgraph can correspond to the potential links that are feasible under the current operating conditions for communication network 100.

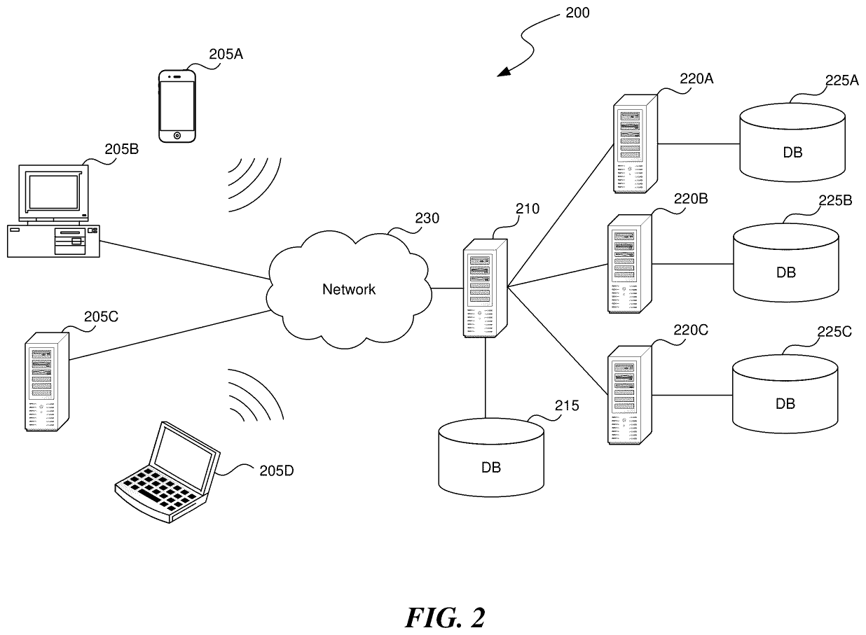

In some implementation, a communication network with free-space optics communication may comprise a heterogeneous mix of sub-networks. FIG. 2 is an example of a heterogeneous communication network that may be implemented using free-space optical communication. Communication network 200 may be similar to communication network 100 of FIG. 1. For example,

As described above, free-space optics communication (FSOC) may offer a wireless networking option that differs from the Radio Frequency (RF) or microwave communication in modern wireless communication due to its high data rate, high capacity, cost-effectiveness, free license spectrum, excellent security, rapid deployment, and the like. For example, in a free-space optical communication system, a transmitter may transmit data at a data rate greater than about 1 Gbps, greater than about 10 Gbps, greater than about 100 Gbps, greater than about 1 Tbps, etc. However, optical signals transmitted through the atmosphere may be affected by the atmosphere before arriving at a line-of-sight receiver. Atmospheric effects, such as atmospheric turbulence, may deteriorate free-space laser beam transmission by reducing the overall optical power level received by a detector of the receiver due to atmospheric attenuation, and/or causing random optical power fluctuations in the received signal resultant from beam deformation, scintillation effects, beam wander, and the like. To overcome such effects of the atmosphere on the transmitted laser beam, adaptive optics may be used to correct the phase perturbations (aberrations) in the received light beam, such that the received light beam may be focused into a single symmetric (e.g., circular) light spot that can be more efficiently coupled into the fiber. An adaptive optics system may generally estimate the phase perturbations (aberrations) of the received light beam and generate additional phase changes conjugated with the estimated phase perturbations in the received light beam (e.g., using a deformable mirror or an SLM) to compensate for the disturbances. In many AO systems, the performance of phase-only AO compensation may be limited due to, for example, limited accuracy and/or resolution of the phase aberration estimation or measurement, and/or limited phase compensation range, resolution, accuracy, and speed of the phase compensation components (e.g., deformable mirrors or SLMs).

FIG. 2 is a block diagram illustrating an overview of an environment 200 in which some implementations of the disclosed technology can operate. Environment 200 can include one or more client computing devices 205A-D, examples of which can include one or more of devices 102, 104, 105, 106, 108, 110, or 900. Client computing devices 205 can operate in a networked environment using logical connections through network 230 (e.g., which may include, in whole or in part, network 100) to one or more remote computers, such as a server computing device.

In some implementations, server 210 can be an edge server which receives client requests and coordinates fulfillment of those requests through other servers, such as servers 220A-C. Server computing devices 210 and 220 can comprise computing systems, such as device 900. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server/client devices. Server 210 can connect to a database 215. Servers 220A-C can each connect to a corresponding database 225A-C. As discussed above, each server 220 can correspond to a group of servers, and each of these servers can share a database or can have their own database. Databases 215 and 225 can warehouse (e.g., store) information such as user profile, context for a real-world element, training data, and the like. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. Network 230 may be the Internet or some other public or private network. Client computing devices 205 can be connected to network 230 through a network interface, such as by wired or wireless communication. While the connections between server 210 and servers 220 are shown as separate connections, these connections can be any kind of local, wide area, wired, or wireless network, including network 230 or a separate public or private network.

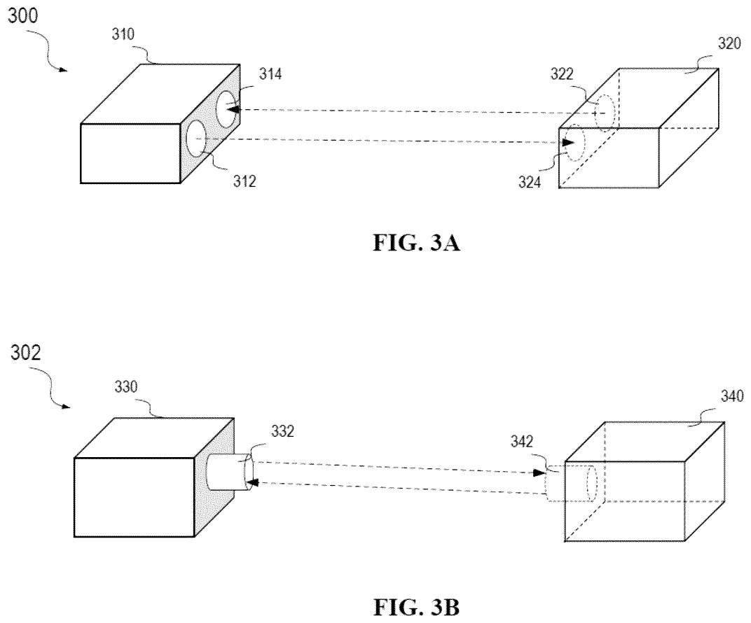

FIG. 3A is an example of a bistatic FSOC system 300. In the illustrated example, a first FSOC terminal 310 may include a transmit subsystem 312 and a receive subsystem 314, where transmit subsystem 312 and receive subsystem 314 may use different optical apertures and different optical antennas and other optics. Similarly, a second FSOC terminal 320 may include a transmit subsystem 322 and a receive subsystem 324, where transmit subsystem 322 and receive subsystem 324 may use different optical apertures and different optical antennas and other optics. When a communication link is established between FSOC terminals 310 and 320, transmit subsystem 312 may transmit light signals to FSOC terminal 320, which may receive the light signals from FSOC terminal 310 using receive subsystem 324. Similar, transmit subsystem 322 may transmit light signals to FSOC terminal 310, which may receive the light signals from FSOC terminal 320 using receive subsystem 314.

Since each bistatic FSOC terminal may need to include separate transmit subsystem and receive subsystem, the bistatic FSOC terminal may include more components (e.g., two sets of optical antennas and other optics). Further, the bistatic FSOC terminal may need additional beam dump and power meter configurations to effectively absorb and measure energy of light passed, scattered, or deflected within terminals 310 and 320. As such, the bistatic FSOC terminal may be complex, bulky, heavy, more expensive, and more difficult to steer. For many FSOC terminals, such as airborne FSOC terminals, it is desirable that the FSOC terminal can be smaller, lighter, cheaper, and easier to steer.

FIG. 3B is an example of a monostatic free-space optical communication system 302. In the illustrated example, a first FSOC terminal 330 may include a transceiver system 332, where light to be transmitted into atmosphere and light received from the atmosphere may pass through a common aperture and a common optical path (e.g., a same optical antenna). Similarly, a second FSOC terminal 340 may include a transceiver system 342, where light to be transmitted into atmosphere and light received from the atmosphere may pass through a common aperture and a common optical path. When a communication link is established between FSOC terminals 330 and 340, transceiver system 332 may transmit light signals to FSOC terminal 340 using a light beam in a first infrared wavelength band, and transceiver system 342 of FSOC terminal 340 may receive the light signals transmitted from FSOC terminal 330. Transceiver system 342 of FSOC terminal 340 may simultaneously transmit light signals to FSOC terminal 330 using a light beam in a second infrared wavelength band, and transceiver system 332 of FSOC terminal 330 may receive the light signals transmitted from FSOC terminal 340.

Since each monostatic FSOC terminal as shown in FIG. 3B may use the same optical antenna and some other common optical components for both transmitting optical signals and receiving optical signals, the terminal may use fewer component, and may be less complex, smaller, lighter, cheaper, and easier to steer. However, it can be very challenging to isolate the light signals to be transmitted from the received light signals to prevent the light signals to be transmitted from contaminating the received light signals.

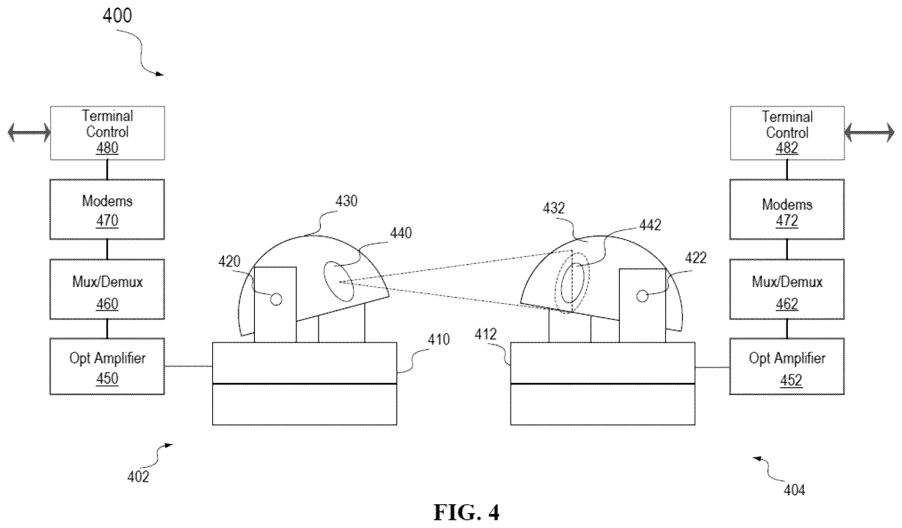

FIG. 4 includes simplified block diagrams of examples of terminals in a free-space optical communication system 400 according to some implementations. A first terminal 402 of FSOC system 400 may include a station 410, which may be fixed or may be steerable (e.g., rotatable). A terminal head 430 of first terminal 402 may be coupled to station 410 through gimbal structure 420, which may pivot, tilt, rotate terminal head 430 and, alone or in combination with station 410, steer terminal head 430 such that a transmit/receive aperture 440 on terminal head 430 of first terminal 402 may face a second terminal 404 for communication with a second terminal 404. Terminal head 430 may include one or more optical antennas for transmitting and/or receiving laser beams, and may also include adaptive optics for aberration correction. For example, first terminal 402 may be a monostatic FSOC terminal as described above with respect to FIG. 3B and described in more detail below. First terminal 402 may include a back end that may include, for example, one or more optical amplifiers 450 (e.g., one or more EDFAs) that may amplify the received light beam or the light beam to be transmitted. A multiplexer/demultiplexer 460 of the back end may multiplex modulated light beams from multiple modulator/demodulators (modems) 470 (and in multiple wavelength bands) into a single light beam to be transmitted, and may demultiplex a received light beam into multiple light beams in different respective wavelength bands, which may then be detected and demodulated by multiple modems 470. The back end of first terminal 402 may also include a terminal control module 480 that may include other circuits, software, and/or firmware, such as network interface cards, network switch, power management circuits, controllers, user interfaces, and the like.

Similarly, second terminal 404 may include a station 412, which may be fixed or may be steerable (e.g., rotatable). A terminal head 432 of second terminal 404 may be coupled to station 410 through a gimbal structure 422, which may rotate terminal head 432 and, alone or in combination with station 412, steer terminal head 432 such that a transmit/receive aperture 442 of second terminal 404 may face first terminal 402 for point-to-point optical communication with first terminal 402. Terminal head 432 may include one or more optical antennas for transmitting and/or receiving laser beams, and may also include adaptive optics for aberration correction. For example, second terminal 404 may be a monostatic FSOC terminal as described above with respect to FIG. 3B and described in more detail below. Second terminal 404 may include a back end that may include, for example, one or more optical amplifiers 452 (e.g., EDFAs) that may be used to amplify the received light beam or the light beam to be transmitted. Second terminal 404 may also include a multiplexer/demultiplexer 462 that may be used to multiplex modulated light beams from multiple modems 472 (and in multiple wavelength bands) into a single light beam to be transmitted, or may demultiplex a received light beam into multiple light beams in different respective wavelength bands, which may be detected and demodulated by multiple modems 472. The back end may also include a terminal control module 482 that may include other circuits, software, and/or firmware, such as a network interface card, a network switch, power management circuits, one or more controllers, a user interface, and the like.

To start a communication link between first terminal 402 and second terminal 404, first terminal 402 may receive information (e.g., location information) of second terminal 404, and may steer terminal head 430 to point to second terminal 404 and transmit a laser beam (e.g., a beacon beam) towards second terminal 404. Additionally or alternatively, second terminal 404 may receive information (e.g., location information) of first terminal 402, and may steer terminal head 432 to point to first terminal 402 and transmit a laser beam towards first terminal 402. First terminal 402 may steer terminal head 430 to try to acquire the laser beam transmitted by second terminal 404 to establish a link between first terminal 402 and second terminal 404. Additionally or alternatively, second terminal 404 may steer terminal head 432 to try to acquire the laser beam transmitted by first terminal 402 to establish a link between first terminal 402 and second terminal 404. Data transmission may begin after the link is established.

During the data transmission, light beams received by the optical antenna of a terminal may be corrected by adaptive optics of the terminal and coupled into a terminal receiver for light detection and signal demodulation as described herein. In many AO systems, the performance of phase-only AO compensation may be limited due to, for example, limited accuracy and/or resolution of the phase aberration estimation or measurement, and/or limited phase compensation range, resolution, accuracy, and speed of the phase compensation components (e.g., deformable mirrors or SLMs). For example, real-time adaptive optics may need to use phase wavefront measurement results, which may be difficult to measure in some communication scenarios. According to certain embodiments, to improve the performance of the adaptive optics system of an FSOC terminal, aberrations in different spatial and/or temporal frequency bands may be corrected using different techniques.

Implementations resolve connections among nodes of a dynamic network using machine learning. A “machine learning model,” as used herein, refers to a construct that is configured (e.g., trained) to make predictions, provide probabilities, augment data, and/or generate data. For example, the machine learning model can be trained via a loss function, reward function, or any other suitable function that evaluates the inferences of the model. The architecture of implemented machine learning model(s) can include any suitable machine learning model components. For example, a neural network can be implemented along with a technique to propagate a gradient through the neural network for trainings its weights. The neural network can include any number of hidden layers (e.g., 0, 1, 2, 3, or many more), and can include feed forward neural networks, recurrent neural networks, convolution neural networks, transformer networks, encoder-decoder architectures, large language model(s), any other suitable type, or combinations thereof. In some implementations, the neural network can be configured for deep learning, for example based on the number of hidden layers and types implemented.

In some implementations, machine learning model(s) comprising a neural network can be trained using a reward or utility function. For example, reinforcement learning can be used to train the neural network via a reward function that evaluates predictions generated by the neural network during training. Based on output(s) from the reward function (e.g., score(s) for the neural network's prediction(s)), gradient(s) can be calculated and propagated through the neural network. The propagated gradient(s) can alter the weights of the neural network to improve the reward function's evaluation of the model's predictions. In some implementations, the reinforcement learning implemented can include deep Q-learning. For example, a loss can be calculated using the output from the reward function and a target value, and gradient descent can be used to propagate gradient(s) through the neural network. In another example, the reinforcement learning implemented can include policy gradient techniques (e.g., REINFORCE, etc.), such as actor-critic techniques or any other suitable policy gradient algorithm. Similarly, policy gradient(s) can be calculated based on the output of the reward function, gradient(s) for the weights of the neural network can be calculated using the policy gradient(s), and the neural network gradient(s) can be propagated through the neural network. Any other suitable reinforcement learning technique, gradient calculations that relate reinforcement learning model(s) to neural network accuracy, and neural network gradient propagation can be implemented.

In some implementations, machine learning model(s) can be an ensemble learning model. Multiple models can be stacked, for example with the output of a first model feeding into the input of a second model. Some implementations can include a number of layers of prediction models. In some implementations, features utilized by machine learning model(s) can also be determined, for example via any suitable feature engineering techniques.

In some implementations, the design of machine learning model(s) can be tuned during training, retraining, and/or updated training. For example, tuning can include adjusting a number of hidden layers in a neural network, an architecture of the layers, and the like. This tuning can also include adjusting/selecting features used by the machine learning model(s). Various tuning configurations (e.g., different versions of the machine learning model and features) can be implemented while training in order to arrive at a configuration for machine learning model(s) that, when trained, achieves desired performance (e.g., performs predictions at a desired level of accuracy, run according to desired resource utilization/time metrics, and the like). The training of implemented machine learning model(s) can be updated, for example based on an updated loss and/or reward functions, new variations of input data, or any other suitable trigger for updating the training of model(s).

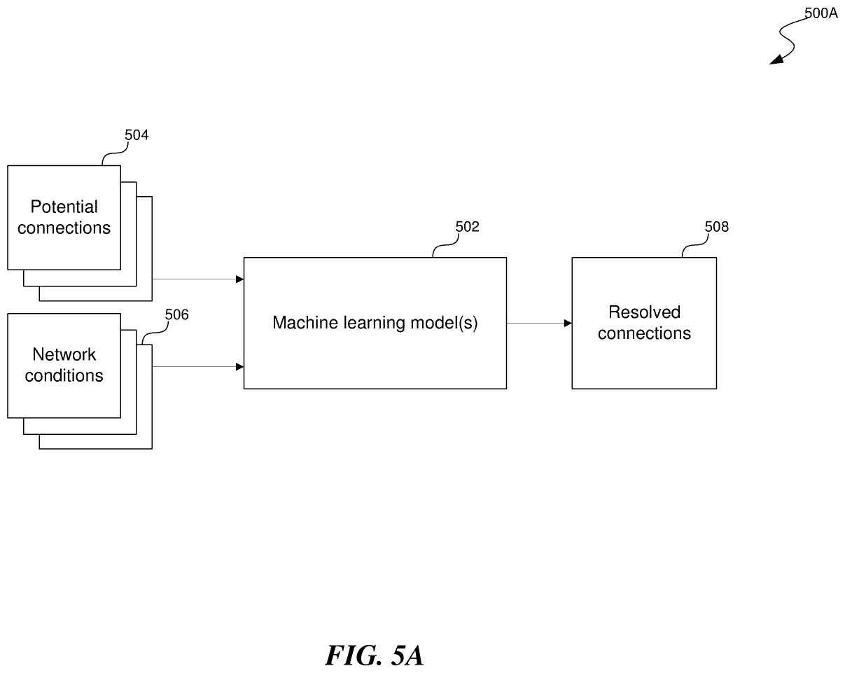

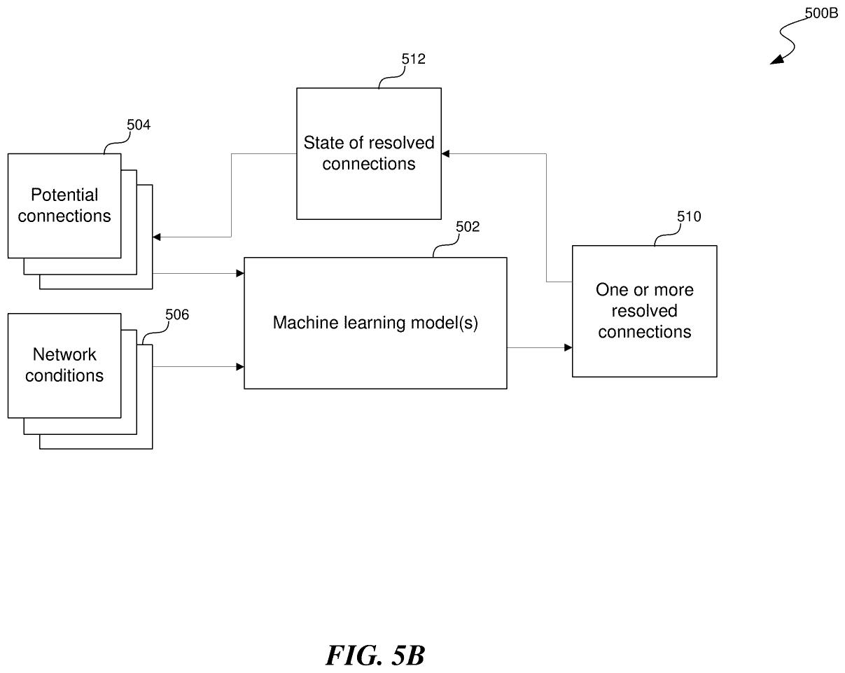

FIG. 5A is an example of a machine learning model architecture for resoling network connections to define a topology for a dynamic network. Diagram 500A illustrates machine learning model(s) 502, potential connections 504, network conditions 506, and resolved connections 508. In some implementations, machine learning model(s) 502 can be trained to resolve connections among nodes of a dynamic network to define a topology for the dynamic network. The dynamic network can comprise an FSOC network and at least a portion of the dynamic network's nodes can be FSOC nodes. In some implementations, the dynamic network is a heterogeneous network that comprises different sub-networks, such as a wired network, cellular/RF network, FSOC network, and the like, and different variations of network nodes. For example, the dynamic network can comprise a variety of nodes with modifiable connections, such as FSOC nodes, RF nodes, and any other suitable nodes.

Machine learning model(s) 502 can comprise a trained neural network or any other suitable machine learning model(s). For example, machine learning model(s) 502 can be a neural network trained using reinforcement learning, such as via a reward function that evaluates the model's predictions. Machine learning model(s) 502 can be trained to resolve modifiable connections among nodes (e.g., point-to-point connections between pairs of FSOC nodes/RF nodes, or any other suitable connections) of the dynamic network to define a topology for the dynamic network. For example, machine learning model(s) 502 can receive, as input, potential connections 504 and network conditions 506, and generate, as output, resolved connections 508. In some implementations, output from machine learning model(s) 502 can comprise a data structure with corresponding scores (e.g. numeric values, probabilities, etc.) for multiple of the potential connections of the dynamic network (e.g., each of the potential connections), and resolved connections 508 can correspond to potential connection(s) between individual node(s) with a score that meets a selection criteria (e.g., the highest probability, probabilities that meet a threshold, etc.).

Potential connections 504 can be a data structure that represents the potential connections among nodes of the dynamic network. For example, the data structure can be a vector with entries that each represent a potential connection between specific nodes and values that represent whether the specific nodes are connected in the representation. In some implementations, potential connections 504 represents the potential connections among nodes and a state for these potential connections (e.g., connected or unconnected). In this example, the universe of potential connections provided to machine learning model(s) 502 via potential connections 504 includes a subset of connected nodes (e.g., a partial topology for the dynamic model). The output from machine learning model(s) 502 in this example, resolved connections 508, can include one or more additional connections beyond the subset of connected nodes. In other words, potential connections 504 can include one or more connections among nodes and machine learning model(s) 502 can resolve additional connection(s) among nodes. Potential connections 504 can by any other suitable data structure that represents potential connections among nodes and/or states for these potential connections.

Network conditions 506 can be conditions for components of the dynamic network, such as conditions relative to each of the nodes. Network conditions 506 can include environmental conditions or other network conditions relative to the nodes of the network (e.g., heat and/or temperature metric(s), precipitation metric(s), cloud coverage metric(s), fog metric(s), air turbulence metric(s), etc.), data rates and/or historical data rates between nodes, hardware (e.g., antenna type, optical transmitter/receiver, etc.) used at each node endpoint, available connection types that can be established between nodes, node movement rates/historical likelihood of movement, historical node reliability/uptime, distance between nodes, and any other suitable environmental and/or network conditions. Examples of environmental conditions relative to the physical location (e.g., geographic location) of a node include: pressure metric(s) (e.g., pressure level(s) in pascals, pressure level(s) at different heights, etc.), cloud temperature metric(s) (e.g., cloud temperatures at different heights), temperature metric(s) (e.g., air temperature at different heights, ground temperature, temperature near node, etc.) water vapor pressure metric(s) (e.g., pressure level(s) at different heights, etc.), rain height metric(s), rain rate metric(s), cloud ceiling metric(s) (e.g., height when cloud density meets a threshold), cloud thickness (e.g., cloud layer thickness metric(s), cloud water density metric(s), etc.). In some implementations, network conditions 506 comprise a set of network condition instances for each of the nodes of the dynamic network. In this example, machine learning model(s) 502 can generate resolved connections 508 using multiple instances network conditions relative to individual ones of the nodes of the dynamic network (network conditions 506).

In some implementations, machine learning model(s) 502 can be deployed on multiple processing units, and each instance can independently select connections using resolved connections 508 (e.g., data structure of scores for the potential connections of the dynamic network). For example, the instances can select connections according to the output scores, randomly, or via any other suitable selection technique. The network topologies resolved by the instances can be evaluated in parallel simulated environments. The highest performing resolved topology according to the simulated environments may then be used to configure the dynamic network.

In some implementations, resolved connections 508 comprise a network topology for the dynamic network, such as states for connections among nodes of the dynamic network that define a structure for the network. In some implementations, machine learning model(s) 502 iteratively generate one or more resolved connections 502 to define the network topology for the dynamic network.

FIG. 5B is an example of a machine learning model architecture that iteratively resolves network connections to define a topology for a dynamic network. Diagram 500B illustrates machine learning model(s) 502, potential connections 504, network conditions 506, one or more resolved connections 510, and state of resolved connections 512. For example, potential connections 504 and network conditions 506 can be input to machine learning model(s) 502 to generate one or more resolved connections 510. In some implementations, diagram 500B illustrates an iterative approach to building state of resolved connections 512. For example, instances of potential connections 502 and network conditions 506 can be provided to machine learning model(s) 502 to generate instances of one or more resolved connections 510.

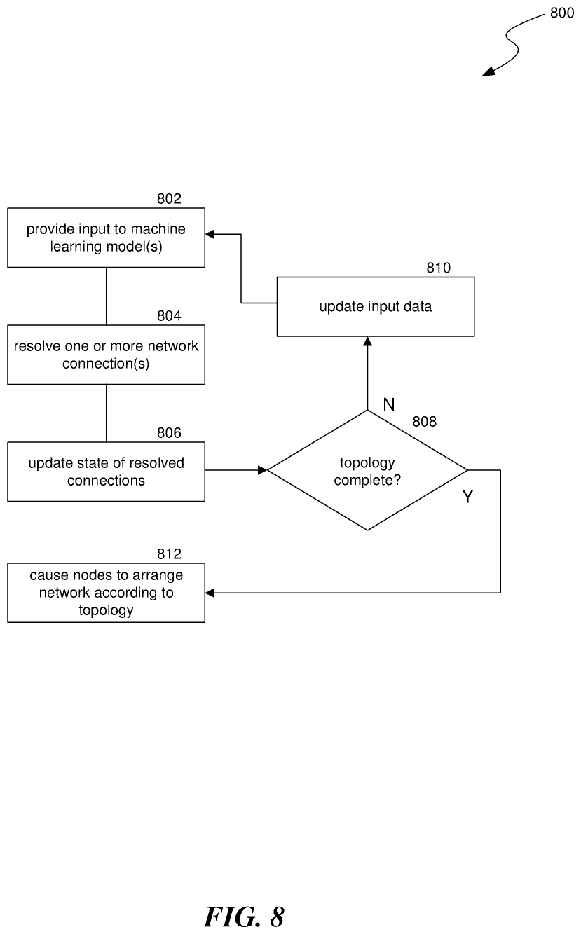

During each iteration, the one or more resolved connections 516 generated by machine learning model(s) 502 can update state of resolved connections 512. For example, state of resolved connections 512 can represent a topology for the dynamic network that is built over iterations. Between iterations, state of resolved connections 512 can update potential connections 512 such that the partial topology for the dynamic network is included in potential connections 512. In this example, machine learning model(s) 512 can iteratively build upon the partial topology for the dynamic network until a complete topology is completed. Process 800 of FIG. 8 further describes iteratively building a complete topology for the dynamic network.

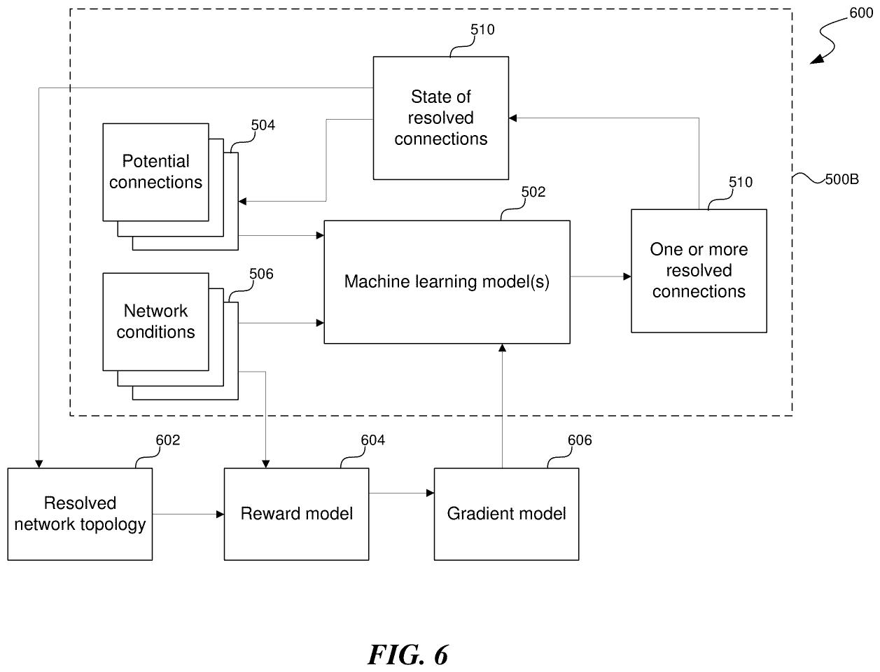

Machine learning model(s) 502 can be trained via a machine learning model training procedure. FIG. 6 is an example of an architecture for training a machine learning model that iteratively resolves network connections to define a topology for a dynamic network. Diagram 600 illustrates resolved network topology 602, reward model 604, and gradient model 606, as well as diagram 500B of FIG. 5, which includes machine learning model(s) 502, potential connections 504, network conditions 506, one or more resolved connections 510, and state of resolved connections 512.

In some implementations, the components of diagram 500B can iteratively build a resolved network topology for a dynamic network. For example, state of resolved connections 510 can be iteratively built into resolved network topology 602. Resolved network topology 602 can represent connections among nodes of the dynamic network, such as point-to-point connections between individual ones of these nodes. Reward model 604 can evaluate structure of resolved network topology 602 based on network conditions 506. Examples network conditions include: environmental conditions or other network conditions relative to the nodes of the network (e.g., heat and/or temperature metric(s), precipitation metric(s), cloud coverage metric(s), etc.), data rates and/or historical data rates between nodes, hardware (e.g., antenna type, optical transmitter/receiver, etc.) used at each node endpoint, available connection types that can be established between nodes, node movement rates/historical likelihood of movement, historical node reliability/uptime, node distances, and any other suitable environmental and/or network conditions

Output from reward model 604 can be calculated evaluation metric(s) for resolved network topology 602. For example, reward model 604 can comprise one or more reward functions that evaluate resolved network topology 602, using network conditions 506, based on a combination of criteria. In some implementations, reward model 604 can evaluate the link integrity for connections among nodes of the dynamic network, such as the universe of potential connections among the nodes. The evaluated link integrity can comprise estimated connection characteristics, such as data rate, latency, reliability, error rate, signal quality (e.g., signal to noise ratio, etc.), and the like. In some implementations, the evaluated link integrity can comprise an evaluation for an RF connection and/or an optical connection (e.g., FSOC connection).

The link integrity for a potential connection between two nodes can vary based on conditions at the nodes (e.g., environmental conditions, such as cloud metric(s), precipitation metric(s), heat metric(s), and other weather conditions), other links/connections among nodes of the dynamic network (e.g., links/connections that may cause interference, etc.), a time of day (e.g., interference cause by object(s) in space, the earth, etc.), node location, and other suitable factors. Reward model 604 can include one or more models that evaluate the integrity of links (e.g., RF connections, FSOC connections, etc.) for the potential connections among nodes of the dynamic network. In some implementations, published models/libraries that estimate RF link and/or FSOC link integrity using environmental conditions and/or other node conditions can be utilized by reward model 604. In some implementations, historical data that represents connection integrity among nodes given varying node conditions can be used by reward model 604 to evaluate link integrity.

Reward model 604 can include one or more reward functions that utilize the outputted link evaluations (e.g., estimated connection characteristics for the potential connections among nodes) to predict a topology for the dynamic network that optimizes network criteria given network conditions 506. Example network criteria to optimize include number of connected nodes, network data rate(s), network latency, network reliability, network coverage, and the like. In some implementations, a current topology for the dynamic network (or simulated current topology) and resolved network topology (e.g., resolved network topology 602, candidate topologies iterated over to optimize network criteria, etc.) can be compared to estimate a topology delta for a given resolved topology, or metric(s) representative of connection changes for modifying from the current topology to the resolved topology. In some examples, the network criteria to optimize can include the topology delta. The reward function(s) can weigh different criteria such that one or more dynamic network topologies that optimize the reward function(s) can be determined.

In some implementations, reward model 604 can include reinforcement learning techniques, such as deep Q-learning and/or policy gradient techniques, that utilize the reward function(s) to evaluate resolved network topology 602. The output evaluation metric(s) from reward model 604 can be provided to gradient model 606. Gradient model 606 can calculate a gradient, or other suitable weight adjustment, for adjusting the weights of machine learning model(s) 502 based on the calculated evaluation metric(s). For example, output from deep Q-learning algorithm(s) and/or policy gradient algorithm(s) can be used to generate gradient(s) that improve the performance of machine learning model(s) 502 with respect to the evaluation(s) calculated by reward model 604.

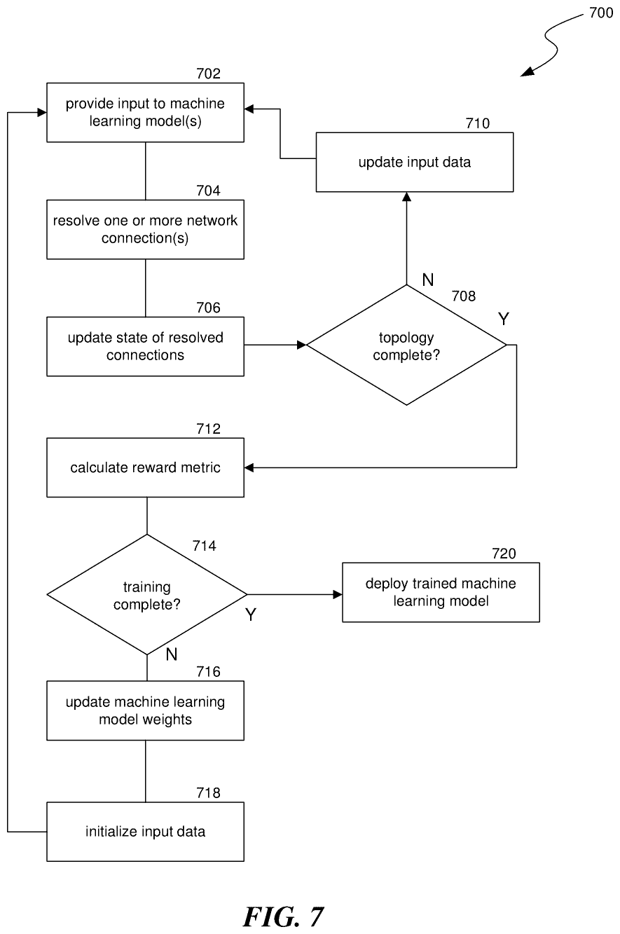

In some implementations, machine learning model(s) 502 can comprise a neural network comprising neurons, and the gradient/weight adjustment(s) can modify the weights of the neurons. Gradients propagated by gradient model 606, such as via gradient descent or any other suitable gradient propagation technique, can train machine learning model(s) 502 to perform better with respect to evaluation via reward model 604. In some implementations, diagram 600 illustrates an iterative approach to training machine learning model(s) 502. For example, several instances of resolved network topology 602, evaluation metric(s) calculated via reward model 604, and gradients/weight adjustment(s) implemented by gradient model 606, or training rounds, can be iterated over to train machine learning model(s) 502. Process 700 of FIG. 7 further describes training machine learning model(s) to resolve network connections for a dynamic network.

FIG. 7 is a flow diagram illustrating a process used in some implementations for training a machine learning model that iteratively resolves network connections to define a topology for a dynamic network. In some implementations, process 700 can be performed on-demand, periodically (e.g., every day, week, month, etc.), or in response to any suitable trigger to train a machine learning model (e.g., upon gathering a threshold amount of new training data, etc.). Process 700 can be performed via cloud computing systems, edge computing systems, on-premises computing systems, terrestrial computing systems, extra-terrestrial computing systems, stationary or mobile computing systems, any combination thereof, or any other suitable computing systems.

At block 702, process 700 can provide input to machine learning model(s). Process 700 can train machine learning model(s) to resolve network connections among nodes of a dynamic network using instances of input data. In some implementations, the machine learning model(s) can comprise weights initialized for training, such as initialized weights of a neural network. Example inputs include network conditions relative to the nodes of the dynamic network and a representation of a universe of potential connections among the nodes of the dynamic network. Examples network conditions include: environmental conditions or other network conditions relative to the nodes of the network (e.g., heat and/or temperature metric(s), precipitation metric(s), cloud coverage metric(s), etc.), data rates and/or historical data rates between nodes, hardware (e.g., antenna type, optical transmitter/receiver, etc.) used at each node endpoint, available connection types that can be established between nodes, node movement rates/historical likelihood of movement, historical node reliability/uptime, node distances, and any other suitable environmental and/or network conditions. The dynamic network can comprise nodes with modifiable connections, such as FSOC nodes, RF nodes, and any other suitable nodes with modifiable connections.

At block 704, process 700 can resolve one or more network connections. For example, an architecture for the machine learning model(s) can be configured to receive an instance of input data and generate one or more resolved network connections among nodes of the dynamic network. In some implementations, machine learning model(s) iteratively resolve a single connection between two nodes of the dynamic network for each instance of input data. In some implementations, machine learning model(s) iteratively resolve multiple connections among nodes of the dynamic network for each instance of input data.

At block 706, process 700 can update a state of resolved network connections. For example, machine learning model(s) can iteratively resolve one or more connections for each instance of input data. The state of resolved network connections can be updated to include the resolved connections from the current instance of input data. In some implementations, the state of resolved network connections represents a partial or whole topology for the dynamic network. For example, iterations between blocks 702-710 can populate the state of resolved network connections with resolved connections until a whole topology for the dynamic network is achieved.

At block 708 process 700 can determine whether the dynamic network topology is complete. The state of resolved network connections can represent a partial or whole topology for the dynamic network, for example based on iterations between blocks 702-710 that populate it with resolved network connections. In some implementations, the state of resolved network connections can be determined to be complete when successive iterations do not update it with new network connections (e.g., network connection(s) resolved during the current iteration via the current instance of input data). In this example, the lack of a new resolved connection can indicate that the topology is complete. In another example, the state of resolved network connections can be determined to be complete when a threshold percentage of nodes of the dynamic network (e.g., 100%, 90%, 80%, etc.) comprises a resolved network connection and/or a threshold percentage (e.g., 100%, 90%, 80%, etc.) of a predefined subset of the nodes of the dynamic network (e.g., core nodes of the dynamic network) comprise a resolved network connection. Any other suitable technique can be used to determine that the state of resolved network connections is a complete topology for the dynamic network. When the dynamic network topology is not determined to be complete, process 700 can progress to block 710. When the dynamic network topology is determined to be complete, process 700 can progress to block 712.

At block 710, process 700 can update the input data for the machine learning model(s). An example instance of input data includes network conditions relative to the nodes of the dynamic network and a representation of a universe of potential connections among the nodes of the dynamic network. In some implementations, the representation of the universe of potential connections among the nodes of the dynamic network can be updated to reflect the resolved connections from the state of resolved network connections. In this example, the partial topology of the dynamic network is used as part of the input data to the machine learning model(s) such that additional network connection(s) can be resolved to iteratively build the topology for the dynamic network. Process 700 can iterate over blocks 702-710 to build the network topology until, at block 708, it is determined that the network topology is complete and process 700 progresses to block 712.

At block 712, process 700 can calculate evaluation metric(s) for the resolved network topology. For example, reward function(s) can calculate one or more metric(s) that evaluate the efficiency of the dynamic network topology resolved by the machine learning model(s) via iterations over blocks 702-710. The efficiency can be calculated relative to the conditions at the nodes of the dynamic network. In some implementations, reward function(s) can evaluate link integrity metric(s) of the potential connections among nodes of the network (based on the conditions at the nodes) and optimize network criteria using the evaluated link integrity metric(s). Reinforcement learning techniques, such as deep Q-learning and/or policy gradients, can be used to evaluate the resolved network topology using these reward function(s). Any other suitable function(s) can be used to evaluate the resolved topology based on the network conditions and/or any other suitable factors.

At block 714, process 700 can determine whether training of the machine learning model(s) is complete. For example, the performance of machine learning model(s) can be assessed based on the evaluation metric(s) calculated for its resolved network topologies (e.g., outputs from the reward function). Training of the machine learning models can be complete when: the evaluation metric(s) (e.g., over multiple training rounds) meet an efficiency criteria (e.g., target score), a threshold number of training rounds have been performed, any combination thereof, or via any other suitable technique to evaluate the performance of a machine learning model. When training of the machine learning model(s) is not complete, process 700 can progress to block 716. When training of the machine learning model(s) is determined to be complete, process 700 can progress to block 720.

At block 716, process 700 can update weights of the machine learning model(s). For example, the evaluation metric(s), such as the output from a reward function, can be similar to a loss with respect to training the machine learning model(s). Accordingly, gradient(s) can be calculated based on the evaluation metric(s) and propagated through the machine learning model(s) (e.g., weights of a neural network). The applied gradient(s) can improve the performance of the machine learning model(s) with respect to the functions used for evaluation, such as the reward function(s). In some implementations, deep Q-learning, policy gradients, or any other suitable techniques that translate reinforcement learning evaluation to neural network gradients can be utilized to calculate and propagate gradients that train the machine learning model(s) to improve performance relative to evaluation via the reward function(s).

At block 718, process 700 can initialize input data for a round of training. Rounds of training can provide variations of input data to machine learning model(s) such that the models are trained under a robust set of conditions. For example, the network conditions relative to the nodes of the dynamic network can be varied over different rounds of training such that the machine learning model is trained to resolve a topology for the dynamic network in different conditions. In some implementations, historical conditions with respect to nodes of the network can be used to vary the network conditions across rounds of training. In some implementations, historical conditions can be varied to generate synthetic network conditions to vary the training rounds. In some implementations, the connections possible among nodes of a dynamic network can be varied given locations of nodes (e.g. moveable nodes, nodes deployed in space, such as satellites, etc.) and network conditions (e.g., time of day). The state of nodes and/or network conditions can be varied across rounds of training to vary the potential connections among nodes of the network that are possible.

Process 700 can iterate over blocks 702-718 until, at block 714, it is determined that training of the machine learning model(s) is complete and process 700 progresses to block 720. For example, each round of training can comprise of iterations over blocks 702-710 until a network topology is determined to be complete at block 708, and multiple rounds of training can be performed over blocks 702-718 until, at block 714, it is determined that training of the machine learning model(s) is complete.

At block 720, process 700 can deploy the trained machine learning model(s). For example, the trained machine learning model(s) can be deployed such that topologies for a dynamic network can be resolved by the trained models under different operating conditions (e.g., environmental conditions relative to the nodes of the dynamic network).

FIG. 8 is a flow diagram illustrating a process used in some implementations for iteratively resolving network connections to define a topology for a dynamic network. In some implementations, process 800 can be performed on-demand, periodically (e.g., every minute, hour, day, week, etc.), or in response to any suitable trigger to train a machine learning model to resolve a network topology (e.g., upon notification of an atmospheric change, node movement, node availability change, etc.). Process 800 can be performed using machine learning model(s) trained via process 700 of FIG. 7, or trained via any other suitable training procedure. Process 800 can be performed via cloud computing systems, edge computing systems, on-premises computing systems, terrestrial computing systems, extra-terrestrial computing systems, stationary or mobile computing systems, any combination thereof, or any other suitable computing systems.

At block 802, process 800 can provide input to trained machine learning model(s). Example inputs include network conditions relative to the nodes of the dynamic network and a representation of a universe of potential connections among the nodes of the dynamic network. Examples network conditions include: environmental conditions or other network conditions relative to the nodes of the network (e.g., heat and/or temperature metric(s), precipitation metric(s), cloud coverage metric(s), etc.), data rates and/or historical data rates between nodes, hardware (e.g., antenna type, optical transmitter/receiver, etc.) used at each node endpoint, available connection types that can be established between nodes, node movement rates/historical likelihood of movement, historical node reliability/uptime, node distances, and any other suitable environmental and/or network conditions. The dynamic network can comprise nodes with modifiable connections, such as FSOC nodes, RF nodes, and any other suitable nodes with modifiable connections.

In some implementations, the trained machine learning model(s) are configured to iteratively build a state of resolved network connections using instances of input data. For example, the universe of potential connections among the nodes of the dynamic network can be updated per each iteration to reflect the state of resolved network connections. In this example, each iteration can resolve one or more additional network connections for the dynamic model to build the state of resolved network connections until a complete topology for the dynamic network is completed.

At block 804, process 800 can resolve one or more network connections. For example, an architecture for the trained machine learning model(s) can be configured to receive an instance of input data and generate one or more resolved network connections among nodes of the dynamic network. In some implementations, trained machine learning model(s) iteratively resolve a single connection between two nodes of the dynamic network for each instance of input data. In some implementations, trained machine learning model(s) iteratively resolve multiple connections among nodes of the dynamic network for each instance of input data.

At block 806, process 800 can update a state of resolved network connections. For example, trained machine learning model(s) can iteratively resolve one or more connections for each instance of input data. The state of resolved network connections can be updated to include the resolved connections from the current instance of input data. In some implementations, the state of resolved network connections represents a partial or whole topology for the dynamic network. For example, iterations between blocks 702-710 can populate the state of resolved network connections with resolved connections until a whole topology for the dynamic network is achieved.

At block 808 process 800 can determine whether the dynamic network topology is complete. The state of resolved network connections can represent a partial or whole topology for the dynamic network, for example based on iterations between blocks 802-810 that populate it with resolved network connections. In some implementations, the state of resolved network connections can be determined to be complete when successive iterations do not update it with new network connections (e.g., network connection(s) resolved during the current iteration via the current instance of input data). In this example, the lack of a new resolved connection can indicate that the topology is complete. In another example, the state of resolved network connections can be determined to be complete when a threshold percentage of nodes of the dynamic network (e.g., 100%, 90%, 80%, etc.) comprises a resolved network connection and/or a threshold percentage (e.g., 100%, 90%, 80%, etc.) of a predefined subset of the nodes of the dynamic network (e.g., core nodes of the dynamic network) comprise a resolved network connection. Any other suitable technique can be used to determine that the state of resolved network connections is a complete topology for the dynamic network. When the dynamic network topology is not determined to be complete, process 800 can progress to block 810. When the dynamic network topology is determined to be complete, process 800 can progress to block 812.

At block 810, process 800 can update the input data for the trained machine learning model(s). An example instance of input data includes network conditions relative to the nodes of the dynamic network and a representation of a universe of potential connections among the nodes of the dynamic network. In some implementations, the representation of the universe of potential connections among the nodes of the dynamic network can be updated to reflect the resolved connections from the state of resolved network connections. In this example, the partial topology of the dynamic network is used as part of the input data to the trained machine learning model(s) such that additional network connection(s) can be resolved to iteratively build the topology for the dynamic network. Process 800 can iterate over blocks 802-810 to build the network topology until, at block 808, it is determined that the network topology is complete and process 800 progresses to block 812.

At block 812, process 800 can instruct a portion of the nodes of the dynamic network to modify connections among the nodes according to the resolved connections. The connections modified among the portion of nodes can include optical connections (e.g., FSOC connections), RF connections, or any other suitable connections. For example, a portion of nodes can be instructed to modify or initiate point-to-point connections according to the resolved connections between pairs of the nodes. In some implementations, the instructing modifies the nodes to arrange the dynamic network according to the topology defined by the state of resolved network connections (e.g., built over iterations between blocks 802-810).

In some implementations, one or more of the nodes of the dynamic network can be comprised by moveable aircrafts, spacecrafts, watercrafts, satellites, or balloons, and the instructing the portion of the nodes to modify or initiate point-to-point connections causes movement of the one or more nodes. In some implementations, the instructing the portion of the nodes to modify or initiate point-to-point connections causes mechanical movement of antenna/transmitter(s)/receiver(s) and/or electronic modulation of an array of antenna/transmitters/receivers such that the point-to-point connections can be modified or initiated.

In some implementations, data is communicated through the dynamic network arranged according to the defined topology. For example, the point-to-point connections modified or initiated in response to the instructions can carry data between the connected nodes to propagate data throughout the arranged dynamic network. In some implementations, a topology for the dynamic network can be modified according to a frequency, the frequency comprising hourly, daily, weekly, monthly, or any combination thereof. For example, the trained machine learning model(s) can resolve an updated topology for the dynamic model at any suitable frequency or on-demand, such as to accommodate changing network conditions (e.g., environmental conditions at nodes of the dynamic network).

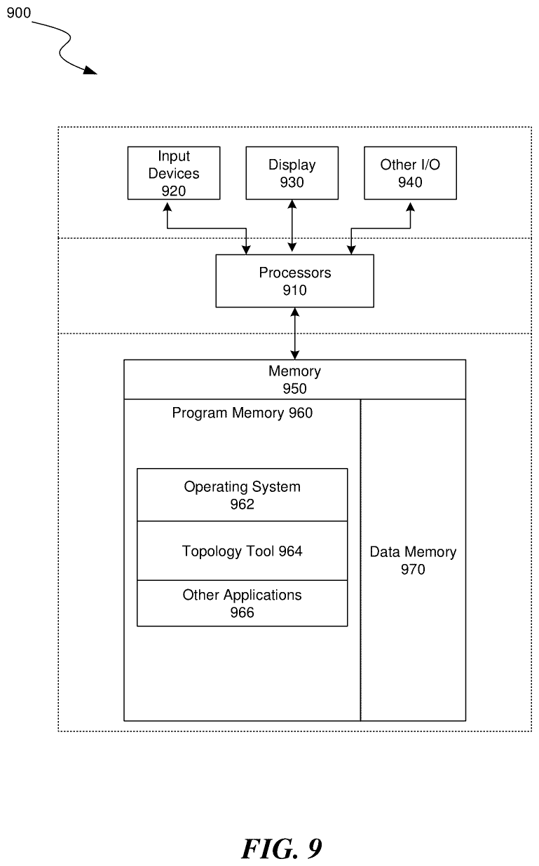

Several implementations are discussed below in more detail in reference to the figures. FIG. 9 is a block diagram illustrating an overview of devices on which some implementations of the disclosed technology can operate. The devices can comprise hardware components of a device 900 that generate recommendations for a person's experience with a real-world element using machine learning. Device 900 can include one or more input devices 920 that provide input to the Processor(s) 910 (e.g., CPU(s), GPU(s), HPU(s), etc.), notifying it of actions. The actions can be mediated by a hardware controller that interprets the signals received from the input device and communicates the information to the processors 910 using a communication protocol. Input devices 920 include, for example, a mouse, a keyboard, a touchscreen, an infrared sensor, a touchpad, a wearable input device, a camera- or image-based input device, a microphone, or other user input devices.

Processors 910 can be a single processing unit or multiple processing units in a device or distributed across multiple devices. Processors 910 can be coupled to other hardware devices, for example, with the use of a bus, such as a PCI bus or SCSI bus. The processors 910 can communicate with a hardware controller for devices, such as for a display 930. Display 930 can be used to display text and graphics. In some implementations, display 930 provides graphical and textual visual feedback to a user. In some implementations, display 930 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network card, video card, audio card, USB, firewire or other external device, camera, printer, speakers, CD-ROM drive, DVD drive, disk drive, or Blu-Ray device.

In some implementations, the device 900 also includes a communication device capable of communicating wirelessly or wire-based with a network node. The communication device can communicate with another device or a server through a network using, for example, TCP/IP protocols. Device 900 can utilize the communication device to distribute operations across multiple network devices.

The processors 910 can have access to a memory 950 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 950 can include program memory 960 that stores programs and software, such as an operating system 962, topology tool 964, and other application programs 966. Memory 950 can also include data memory 970, e.g., training data, environmental conditions, dynamic network data, configuration data, settings, user options or preferences, etc., which can be provided to the program memory 960 or any element of the device 900.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

Reference in this specification to “implementations” (e.g. “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for resolving connections among nodes of a dynamic network based on network conditions, the method comprising:
determining connections among nodes of the dynamic network based on network conditions, wherein:
the nodes comprise free-space optical communication nodes and the connections among the nodes are dynamically modifiable, and
the connections among the nodes are determined by:
providing, to a trained machine learning model, A) one or more network conditions relative to the nodes and B) a representation of a universe of potential connections among the nodes; and
resolving, by the trained machine learning model, connections between pairs of the nodes, wherein the resolved connections define a first topology for the dynamic network; and
instructing at least a portion of the nodes to modify or initiate point-to-point connections according to the resolved connections between pairs of the nodes, wherein:
the instructing modifies the nodes to arrange the dynamic network according to the first topology, and
data is communicated through the dynamic network arranged according to the first topology.

2. The method of claim 1, wherein the first topology for the dynamic network is arranged when the portion of the nodes are modified according to the instructing and another portion of nodes maintain previously established point-to-point connections.

3. The method of claim 1, wherein the trained machine learning model comprises a neural network configured to:
receive, as input, the network conditions relative to the nodes, and the representation of the universe of potential connections among the nodes; and
predict, as output, the resolved connections between pairs of the nodes.

4. The method of claim 3, wherein the trained neural network is trained using reinforcement learning, a reward function that calculates a loss metric used to train weights among neurons of the trained neural network, or any combination thereof.

5. The method of claim 1, wherein the trained machine learning model comprises a trained neural network, and the trained neural network outputs the resolved connections between pairs of the nodes by iteratively:
receiving, as input, the network conditions relative to the nodes, and the representation of the universe of potential connections among the nodes; and
predicting, as output, one or more of the resolved connections between pairs of the nodes;
wherein, between iterations, the representation of the universe of potential connections among the nodes is updated to include the one or more resolved connections predicted in previous iterations.

6. The method of claim 1, wherein one or more of the nodes are comprised by moveable aircrafts, spacecrafts, watercrafts, satellites, or balloons, and the instructing the portion of the nodes to modify or initiate point-to-point connections causes movement of the one or more nodes.

7. The method of claim 1, wherein a topology for the dynamic network is modified according to a frequency, the frequency comprising hourly, daily, weekly, monthly, or any combination thereof.

8. The method of claim 1, wherein the network conditions relative to the nodes comprise one or more of: environmental conditions, data rate metrics and/or historical data rate metrics between nodes, node hardware types, available connection types, node movement metrics, node reliability metrics, or any combination thereof.

9. The method of claim 1, wherein the modifiable connections among the nodes comprise free-space optical communication connections and radio frequency connections.

10. A computer-readable storage medium storing instructions that, when executed by a computing system, cause the computing system to perform a process for resolving connections among nodes of a dynamic network based on network conditions, the process comprising:
determining connections among nodes of the dynamic network based on network conditions, wherein:
the connections among the nodes are dynamically modifiable, and
the connections among the nodes are determined by:
providing, to a trained machine learning model, one or more network conditions relative to the nodes, and a representation of a universe of potential connections among the nodes; and
resolving, by the trained machine learning model, connections among the nodes, wherein the resolved connections define a first topology for the dynamic network; and
instructing at least a portion of the nodes to modify or initiate connections according to the resolved connections;
wherein the instructing modifies the nodes to arrange the dynamic network according to the first topology.

11. The computer-readable storage medium of claim 10, wherein the modifiable connections among the nodes comprise free-space optical communication connections and/or radio frequency connections, the resolved connections comprise connections between pairs of nodes, and the connections that the portion of nodes are instructed to modify or initiate comprise point-to-point connections.

12. The computer-readable storage medium of claim 10, wherein the trained machine learning model comprises a neural network configured to:
receive, as input, the network conditions relative to the nodes, and the representation of the universe of potential connections among the nodes; and
predict, as output, the resolved connections among the nodes.

13. The computer-readable storage medium of claim 12, wherein the trained neural network is trained using reinforcement learning, a reward function that calculates a loss metric used to train weights among neurons of the trained neural network, or any combination thereof.

14. The computer-readable storage medium of claim 10, wherein the trained machine learning model comprises a trained neural network, and the trained neural network outputs the resolved connections among the nodes by iteratively:
receiving, as input, the network conditions relative to the nodes, and the representation of the universe of potential connections among the nodes; and
predicting, as output, one or more of the resolved connections among the nodes;
wherein, between iterations, the representation of the universe of potential connections among the nodes is updated to include the one or more resolved connections predicted in previous iterations.

15. The computer-readable storage medium of claim 10, wherein one or more of the nodes are comprised by moveable aircrafts, spacecrafts, watercrafts, satellites, or balloons, and the instructing the portion of the nodes to modify or initiate point-to-point connections causes movement of the one or more nodes.

16. A computing system for resolving connections among nodes of a dynamic network based on network conditions, the computing system comprising:
one or more processors; and
one or more memories storing instructions that, when executed by the one or more processors, cause the computing system to perform a process comprising:
determining connections among nodes of the dynamic network based on network conditions, wherein:
the connections among the nodes are dynamically modifiable, and
the connections among the nodes are determined by:
providing, to a trained machine learning model, one or more network conditions relative to the nodes, and a representation of a universe of potential connections among the nodes; and
resolving, by the trained machine learning model, connections among the nodes, wherein the resolved connections define a first topology for the dynamic network; and
instructing at least a portion of the nodes to modify or initiate connections according to the resolved connections,
wherein the instructing modifies the nodes to arrange the dynamic network according to the first topology.

17. The computing system of claim 16, wherein the modifiable connections among the nodes comprise free-space optical communication connections and/or radio frequency connections, the resolved connections comprise connections between pairs of nodes, and the connections that the portion of nodes are instructed to modify or initiate comprise point-to-point connections.

18. The computing system of claim 16, wherein the trained machine learning model comprises a neural network configured to:
receive, as input, the network conditions relative to the nodes, and the representation of the universe of potential connections among the nodes; and
predict, as output, the resolved connections among the nodes.

19. The computing system of claim 18, wherein the trained neural network is trained using reinforcement learning, a reward function that calculates a loss metric used to train weights among neurons of the trained neural network, or any combination thereof.

20. The computing system of claim 16, wherein the trained machine learning model comprises a trained neural network, and the trained neural network outputs the resolved connections among the nodes by iteratively:
receiving, as input, the network conditions relative to the nodes, and the representation of the universe of potential connections among the nodes; and
predicting, as output, one or more of the resolved connections among the nodes;
wherein, between iterations, the representation of the universe of potential connections among the nodes is updated to include the one or more resolved connections predicted in previous iterations.
